(19) United States
(12) Patent Application Publication
(10) Pub. No.: US 2004/0064322 A1
(43) Pub. Date: Apr. 1, 2004

(54) Automatic consolidation of voice enabled multi-user meeting minutes

(75) Inventors: Christos H. Georgiopoulos, Gig Harbor, WA (US); Shawn D. Casey, Olympia, WA (US)

Correspondence Address: Pillsbury Winthrop LLP, Intellectual Property Group, 725 South Figueroa Street, Los Angeles, CA, 90017-5443, US

(73) Assignee: Intel Corporation, Santa Clara, CA

(21) Appl. No.: 10/259,317

(22) Filed: Sep. 30, 2002

(51) Int. Cl. G10L 21/00

(52) U.S. Cl. 704/277

(57) ABSTRACT

An arrangement is provided for enabling multi-user meeting minute generation and consolidation. A plurality of clients sign up a meeting session across a network. Each of the clients participating in the meeting session associates with an automatic meeting minute enabling mechanism. The automatic meeting minute enabling mechanism is capable of processing acoustic input containing speech data representing the speech of its associated client in a source language to generate one or more transcriptions based on the speech of the client in one or more destination languages, according to information related to other participating clients. Such generated transcriptions from the plurality of participating clients are consolidated to produce meeting minutes update.

### BACKGROUND

With the advancement of telecommunication technologies, it has become more and more common place for multiple users to hold a meeting session using a communications network to connect participants in different locations, without having to physically be in the same location. Such meeting sessions are sometimes conducted over standard phone lines. Meeting sessions may also be conducted over the Internet, or via proprietary network infrastructures.

Many communication devices that are available on the market are often made capable of connecting to each other via, for example, the Internet. A PC user may talk to another PC user via on-line chat room applications. Such on-line chat rooms applications may operate in a window environment and may require the connected communication devices (in this case PCs) support needed window environments. Applications may need to provide text-editing capabilities so that a user may enter their messages in text form in the window representing a chat room.

Such application requirements may limit users who do not have communication devices that support required functionality. For instance, a user may use a cellular phone with only limited text display capabilities. In this case, the only means for the cellular phone user to enter his/her messages may be through voice instead of text. In addition, when users with different types of devices communicate, their devices may support different functionalities. Furthermore, users of different origins may use different languages to communicate. In such situation, conventional solutions to multi-user meeting sessions fail to work effectively, if not make it impossible.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar parts throughout the several views of the drawings, and wherein:

FIG. 1 depicts an exemplary architecture in which multi-user voice-enabled communication is facilitated based on multiple automatic meeting minute enabling mechanisms, each of which is associated with a corresponding user;

FIG. 2 depicts a different exemplary architecture in which multi-user voice-enabled communication is facilitated based on multiple automatic meeting minute enabling mechanisms, each of which is associated with a corresponding user across a network;

FIG. 3(a) depicts the internal structure of one embodiment of an automatic meeting-minute enabling mechanism with meeting minute consolidation capability;

FIG. 3(b) depicts the internal structure of a different embodiment of an automatic meeting minute enabling mechanism which facilitates meeting minute viewing using meeting minutes update generated elsewhere;

FIG. 3(c) depicts a high level functional block diagram of a mechanism that generates meeting minutes update based on transcriptions generated by different participating clients;

FIG. 4 depicts a high level functional block diagram of an exemplary speech to text mechanism, in relation to an exemplary participating client management mechanism;

FIG. 5 is a flowchart of an exemplary process, in which meeting minutes of a multi-user voice enabled communication session are automatically generated and consolidated;

FIG. 6 is a flowchart of an exemplary process, in which an automatic meeting-minute enabling mechanism generates and consolidates meeting minutes based on information associated with each of multiple users; and

FIG. 7 is a flowchart of an exemplary process, in which spoken words from a user are recognized based on speech input from the user in a source language and translated into a transcription in a destination language.

### DETAILED DESCRIPTION

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software or firmware being run by a general-purpose or network processor. Data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

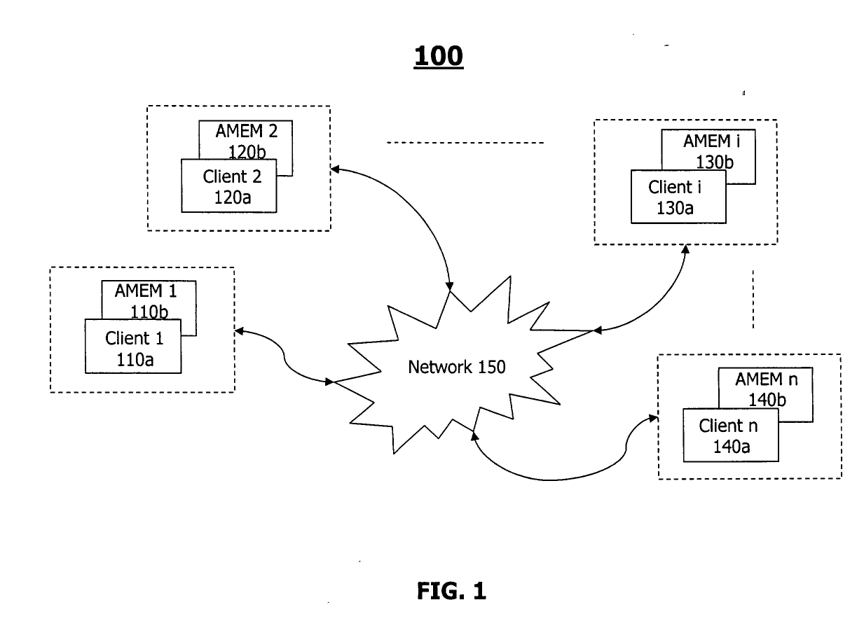

FIG. 1 depicts an exemplary architecture 100 in which multi-user voice-enabled communication is facilitated based on multiple automatic meeting minute enabling mechanisms, each of which is associated with a corresponding user. The architecture 100 comprises a plurality of clients (client 1 110a, client 2 120a, . . . , client i 130a, . . . , client n 140a) that communicate with each other in a meeting or conferencing session through their communication devices (not shown in FIG. 1) via a network 150. A communication device may include a personal computer (PC), a laptop, a personal data assistant (PDA), a cellular phone, or a regular telephone. The network 150 may represent a generic network, which may correspond to a local area network (LAN), a wide area network (WAN), the Internet, a wireless network, or a proprietary network.

The plurality of clients (110a, 120a, . . . , 130a, . . . , 140a) participate in a meeting session, during which the communication among all participating clients may be instantaneous or near instantaneous with limited delay. During the meeting session, each participating client may generate its own messages. In addition, all of the participating clients may be able to access, either on their communication devices or on a local visualization screen, the meeting minutes update constructed based on messages conveyed by different participating clients. For example, a client may communicate via voice with other clients and the speech of the client may be automatically transcribed. Each client may conduct the communication in his/her own preferred or source language. That is, a client may speak out messages in a language preferred by the client. All participating clients may be able to access the spoken messages from other participating clients in textual form, which may be displayed using a preferred destination language desirable to each particular participating client.

To facilitate automated meeting minute generation and consolidation of transcriptions from different participating clients, each of the clients is enabled by an automatic meeting minute enabling mechanism (AMEM) located, for example, at the same physical location as the underlying client. For instance, AMEM 1 110b is associated with the client 1 110a, enabling the client 1 1110a in generating transcriptions based on the speech or textual input of the client 1 110a, receiving meeting minutes update of all the participating clients generated based on their speech or textual inputs, and properly displaying the received meeting minutes update for viewing purposes. Similarly, AMEM 2 120b enables the client 2 120a to perform substantially the same functionality, . . . , AMEM i 130b enables the client i 130a, . . . , and AMEM n 140b enables the client n 140a.

Under the architecture 100, all AMEMs may be deployed on the communication device on which the associated client is running. That is, necessary processing that enables the client in a meeting session may be done on a same physical device. Whenever an underlying client communicates via spoken messages, the associated AMEM may accordingly perform necessary processing of the spoken message to generate a textual message before sending the textual message to other clients participating in the same meeting session. For example, such processing may include transcribing spoken messages in English to produce English text and then translating the English transcription into French before sending the textual message to a participating client whose preferred language is known to be French.

To render different meeting minutes received from other participating clients in a coherent manner for a particular receiving client, the AMEM associated with the receiving client may need to carry out necessary consolidation processing on the received meeting minutes prior to displaying the meeting minutes from different sources to the receiving client. For instance, the AMEM may sort the meeting minutes from different sources first according to time before displaying the content of the meeting minutes. The time may include the creation time of the received minutes or the time they are received. The identifications of the participating clients may also be used as a sorting criterion.

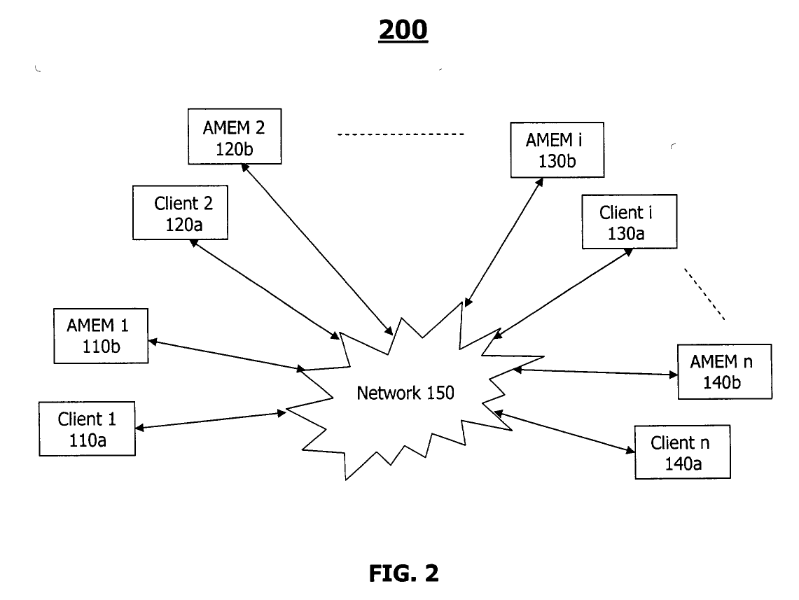

FIG. 2 depicts a different exemplary architecture 200 in which multi-user voice-enabled communication is facilitated based on multiple automatic meeting minute enabling mechanisms, each of which is associated with a corresponding user through a network. In FIG. 2, each of the AMEMs may be deployed on a different physical device from the associated client.

To enable an associate client, an AMEM may communicate with the associated client via a network. For example, AMEM 1 110b may connect to the client 1 110a via the network 150. The network 150 through which the plurality of clients communicate may be the same network through which an AMEM connects to its associated client (as depicted in FIG. 2). It may also be possible that an AMEM connects to its associated client through a different network (not shown in FIG. 2). For example, the AMEM 1 110b may communicate with the client 1 110a via a proprietary network and both may communicate with other participating clients via the Internet.

Yet another different embodiment (not shown in Figures) may involve combination of architecture 100 and architecture 200. That is, some of the AMEMs may be deployed on the same physical communication devices on which their associated clients are running. Some may be running on a different device at a different location (so that such AMEMs are required to connect to their associated clients via a network which may or may not be the network through which the participating clients communicate).

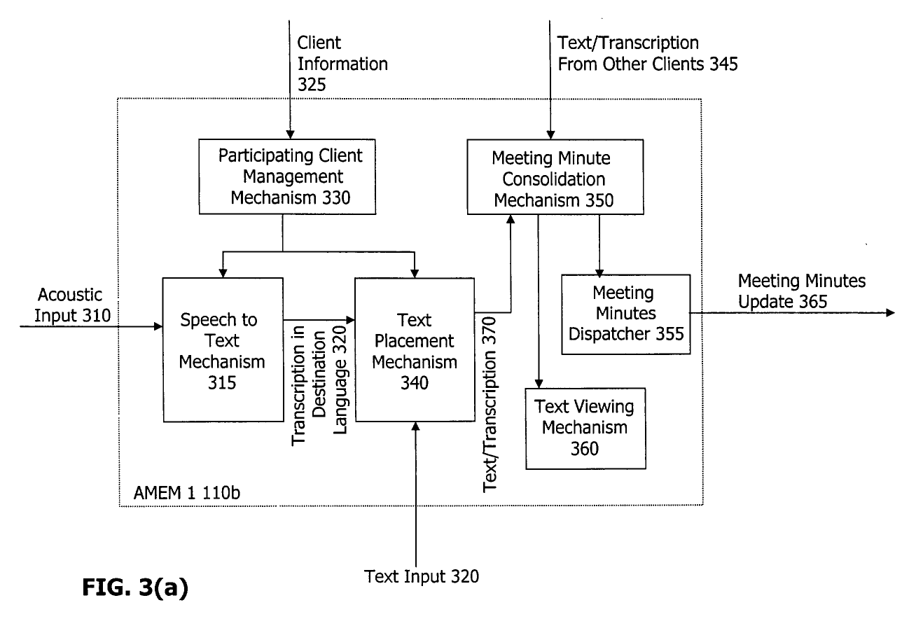

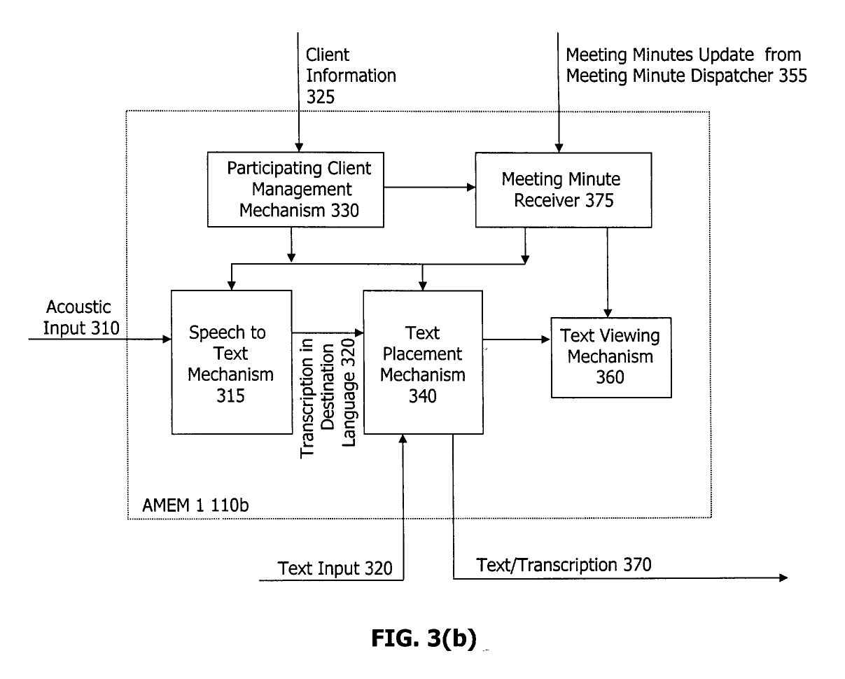

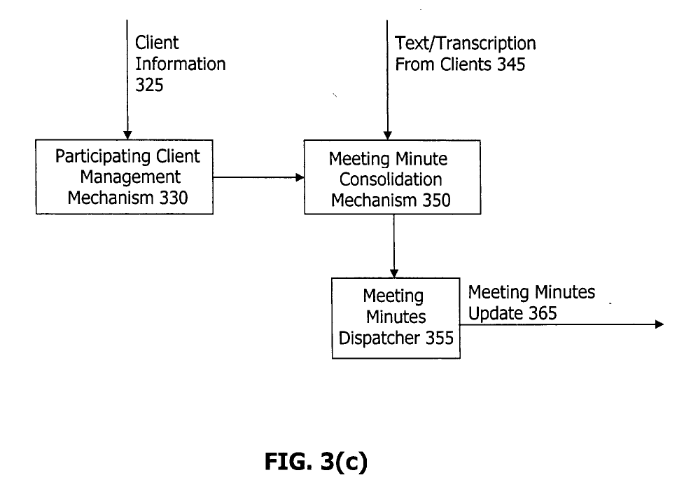

FIG. 3(a) depicts the internal structure of one embodiment of an automatic meeting-minute enabling mechanism (e.g., AMEM 1 110b). The AMEM 1 110b includes a participating client management mechanism 330, a speech to text mechanism 315, a text placement mechanism 340, a meeting minute consolidation mechanism 350, a meeting minute dispatcher 355, and a text viewing mechanism 360. The participating client management mechanism 330 dynamically generates and maintains information about each and every participating client in a meeting session. Such information may be used to determine necessary processing to be performed on the meeting minutes generated based on the client 1's (110a) messages. For instance, when the source language used by the client 1 110a is the same as all other participating clients, there may be no need to translate the meeting minutes from the client 1 110a. This may be determined by the participating client management mechanism 330 based on the information about other participating clients. But if a participating client prefers a different language (destination language), the AMEM 1 110b may have to translate the meeting minutes of the client 1 110a into the destination language prior to sending the client 1's meeting minutes to the participating client.

The speech to text mechanism 315 accepts acoustic input 310 as input and generates transcription in destination language 320 as its output. The acoustic input 310 may include speech of the client 1 110a recorded with, for example, sound of the environment in which the client 1 110a is conducting the meeting session. The speech to text mechanism 315 may generate transcriptions, based on the acoustic input from the client 1 110a, in, for example, destination languages that are suitable for different participating clients. The speech to text mechanism 315 may also be responsible for filtering out acoustic background noise. When the speech to text mechanism 310 is designed to generate transcriptions in destination languages, it may, as depicted in FIG. 3(a), access, via the participating client management mechanism 330, information about the participating clients and use such information to perform speech recognition and translation accordingly.

The transcription generated based on a client's speech may also be translated into destination language(s) at the destination site (instead of at the source site). In this case, the speech from a client may be simply transcribed at the source site into a transcription in the source language and such transcription in a source language may then be sent for the purposes of generating meeting minutes. When such generated meeting minutes are sent to participating clients, each receiving client may then examine whether the content in the meeting minutes is in a language preferred by the receiving client. If the preferred language is not the language used for meeting minutes, the AMEM associated with the receiving client may then be activated to perform the translation from the source language to the destination language. Alternatively, a default language may be defined for each meeting session. Transcriptions and consequently meeting minutes are generated in such defined default language. When a client receives the meeting minutes in the default language, if the default language is not a preferred language of the client, the translation may then take place at the destination site.

Participating clients may specify their preferred languages. The speech to text mechanism 315 may translate the transcription generated based on the speech of the client 1 110a into different languages corresponding to different clients. Transcriptions in languages preferred by a receiving client may be termed as destination transcription. The speech to text mechanism 315 may produce more than one destination transcriptions, corresponding to the transcription from the client 1 110a but expressed in different destination languages.

The text placement mechanism 340 accepts a transcription in a destination language 320 as input and generates properly organized transcription of the client 1 110a before such transcription is consolidated with the transcriptions from other participating clients. The input to the text placement mechanism 340 may be the output of the speech to text mechanism 315 corresponding to automatically generated transcriptions based on the acoustic input 310. Input to the text placement mechanism 340 may also correspond to text input 320 when the underlying client employs a non-speech based method to communicate. For example, a client may simply type the messages on a keyboard.

The difference between the input to the text placement mechanism 340 and the output of the same may be in the format of the text. For instance, a transcription organized in an appropriate form by the text placement mechanism 340 may include different type of information. For example, such information may include the content of the messages, the identification of the client who created the message (i.e., the client 1 110a), the time at which the transcription is created, the source language (the language the client 1 110a is using), the destination language (the language of the recipient) of the transcription, or the location of the client 1 110a. Such information may be formatted in a fashion that is suitable under the circumstances.

Information to be included in an appropriate format of a transcription may be pre-determined or dynamically set up during the meeting session. For instance, an application may specify an appropriate format of a transcription before the application is deployed. It is also possible for a client to dynamically specify the desired information to be included in received meeting minutes when entering into the meeting session. Some of the information may be required such as the identity of the client who generated the transcription or the time the transcription is created.

After a transcription is created in its appropriate form, the text placement mechanism 340 may send the transcription in a destination language corresponding to a participating client and the transcription in the source language to the meeting minute consolidation mechanism 350. The meeting minutes consolidation mechanism 350 is responsible for consolidating transcriptions from different clients to generate meeting minutes update 365 before such meeting minutes update can be viewed by different participating clients.

After receiving transcriptions from different participating clients, the meeting minute consolidation mechanism 350 may organize the received transcription according to predetermined criteria. For example, the meeting minute consolidation mechanism 350 may sort the received transcriptions according to the time stamp which indicates the time by which the transcriptions are created. It may also sort according to identification such as the last names of the participating clients. The organizational criteria may be determined according to either application needs or clients' specifications. Different clients may prefer to view received meeting minutes in specific forms and may indicate such preferred criteria to their corresponding AMEMs.

The meeting minute consolidation mechanism 350 may then send the meeting minutes update 365 to all the participating clients. In the illustrated embodiment in FIG. 3(a), since the meeting minute consolidation mechanism 350 resides in the same device as the AMEM 1 110b, the meeting minutes update 365 are forwarded directly to the text viewing mechanism 360. The text viewing mechanism 360 is responsible for rendering the meeting minutes update for viewing purposes. It may display the meeting minutes update according to some pre-determined format within, for example, in a window on a display screen. Different AMEMs may utilize varying format, depending on the platform on which the associated client is running. For example, for a client that is running on a personal computer, the meeting minutes update may be viewed within a window setting. For a client that is running on a personal data assistant (PDA) that does not support a windowed environment, the meeting minutes update may be displayed in simple text form.

In the framework 100 or 200, there may be at least one AMEM that has a meeting minute consolidation mechanism. In this case, the transcription from other participating clients may simply be sent to the meeting minute consolidation mechanism in the AMEM that has the capability to produce the meeting minutes update. There may also be more than one meeting minute consolidation mechanism running on different AMEMs but only one provides the service at any given time instance. Others may serve as backup service providers. It is also possible that the operations of more than one meeting minute consolidation mechanisms are regulated in some way so that different meeting minute consolidation mechanisms operate alternatively during different sessions of communications.

FIG. 3(b) depicts the internal structure of a different embodiment of an automatic meeting minute enabling mechanism which facilitates meeting minute viewing using meeting minutes update generated elsewhere, according embodiments of the present invention. In this embodiment, the underlying AMEM (e.g., the AMEM 1 110b) does not have a meeting minute consolidation mechanism (350) but it performs other functionalities of an AMEM as described with reference to FIG. 3(a). For example, the AMEM 1 110b includes the participating client management mechanism 330, the speech to text mechanism 315, the text placement mechanism 340, a meeting minute receiver 375, and the text viewing mechanism 360.

In this embodiment (FIG. 3(b)), instead of generating the meeting minutes update locally (as depicted in FIG. 3(a)), the text placement mechanism 340 in the AMEM 1 110b sends properly organized transcription of the underlying client to a meeting minute consolidation mechanism at a different location so that the transcription can be used to generate the meeting minutes update. The AMEM 1 110b then waits until the meeting minute receiver 375 receives the meeting minutes update 365. The meeting minutes update 365 is sent from a meeting minute dispatcher associated with the meeting minute consolidation mechanism. After the meeting minutes update is received, the text viewing mechanism 360 may then display the meeting minutes to the underlying client.

FIG. 3(a) describes an AMEM that includes a meeting consolidation mechanism to facilitate the capability of generating meeting minutes update. FIG. 3(c) depicts a high level functional block diagram of a stand-alone mechanism that is capable of generating meeting minutes update based on transcriptions received from different participating clients. To consolidate transcriptions of different clients to produce the meeting minutes, the participating client management mechanism 330 may be deployed to store and maintain the client information 325. Such client information 325 may be used, by a meeting minute consolidation mechanism 350 to generate, based on received transcriptions 345, the meeting minutes update 365 before a meeting minutes dispatcher 355 sends the consolidate meeting minutes to the client from whom the transcriptions are received.

The mechanism illustrated in FIG. 3(c) may be deployed on a server that connects to the AMEMs associated with different participating clients. Such a configuration (i.e., the meeting minute consolidation mechanism 350 is not deployed on any of the AMEMs of the participating clients) may be used under certain circumstances. For example, if all the participating clients are physically far away from each other, sending transcriptions to a meeting minute consolidation mechanism located at the center to the clients (with shorter and substantially equal distance to all clients) may take less time than sending to any of the AMEMs associated with the participating clients.

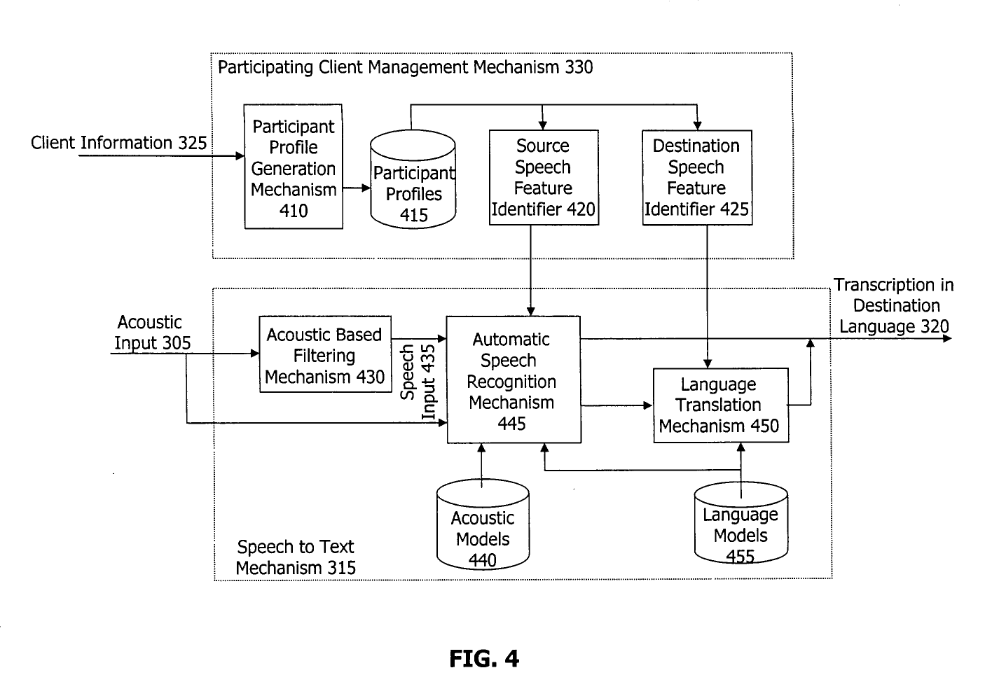

FIG. 4 depicts a high level functional block diagram of an exemplary speech to text mechanism, in relation to an exemplary participating client management mechanism. As discussed earlier, to generate a meeting minute for the client 1 110a, the speech to text mechanism 315 of the AMEM 1 110b accesses certain information about other participating clients to determine necessary processing applied to the speech data of the client 1. That is, the speech to text mechanism 315 may interact with the participating client management mechanism 330.

The participating client management mechanism 330 may comprise a participant profile generation mechanism 410, participant profiles 415, a source speech feature identifier 420, and a destination speech feature identifier 425. The participant profile generation mechanism 410 takes client information as input and generates the participant profiles 415. The participant profiles 415 may include information about each and every participant in a meeting session such as participant's identification, one or more preferred languages, and the platform of the communication device to which the transcriptions will be sent. The generated participant profiles 415 may be accessed later when the underlying AMEM decides how to create the transcription based on information about both the associated client and the receiving participant.

The source speech feature identifier 420 identifies relevant speech features related to a client associated with the underlying AMEM. Such features may include the identification of the associated client as well as the source language that the associated client prefers to use in communication. The source speech feature identifier 420 may be invoked by the speech to text mechanism 315 when a transcription is to be created based on the associated client's speech.

The destination speech feature identifier 425 is responsible for retrieving relevant information about certain participating client. The destination speech feature identifier 425 may be invoked by the speech to text mechanism 315 to determine the preferred language of a participating client in order to decide whether to translate a transcription in a source language into a different destination language with respect to the particular participating client. For example, when the AMEM 1 110b associated with the client 1 110b determines whether the transcription generated based on the speech of the client 1 110a needs to be translated to a different language, the speech to text mechanism of the AMEM 1 110b may activate the destination speech feature identifier in the same AMEM to check whether any of other participating clients prefers a language that is different from the language used by the client 1 100a.

As mentioned earlier, the translation decision may be alternatively made at the destination site (where a receiving client resides). In this case, a participating client may receive transcriptions generated at source sites (based on other participating clients' speech) and may then determine, by the speech to text mechanism 310 at the destination site, by activating the destination speech feature identifier 425 in the same AMEM to determine whether the preferred (destination) language of the receiving client is consistent with the language of the received meeting minutes. As described later, when the destination language differs from a source language, the transcriptions generated at the source may then be translated into destination transcription (either at the source or at the destination site).

The speech to text mechanism 315 includes an acoustic based filtering mechanism 430, an automatic speech recognition mechanism 445, and a language translation mechanism 450. It may further include a set of acoustic models 440 and a set of language models 455 for speech recognition and language translation purposes. Both sets of models are language dependent. For example, the language models used for recognizing English spoken words are different from the language models used for recognizing French spoken words. In addition, acoustic models may even be accent dependent. For instance, an associated client may indicate English as a preferred source language and also specify to have a southern accent. To transcribe the spoken message of the associated client, the automatic speech recognition mechanism 445 may invoke the source speech feature identifier 420 to determine the preferred language and specified accent, if any, before processing the speech of the client. With known information about the speech features of the associated client, the automatic speech recognition mechanism 445 may then accordingly retrieve appropriate language models suitable for English and appropriate acoustic models that are trained on English spoken words based on southern accent for recognition purposes.

The automatic speech recognition mechanism 445 may perform speech recognition either directly on the acoustic input 305 or on speech input 435, which is generated by the acoustic based filtering mechanism 430. The speech input 435 may include segments of the acoustic input 305 that represent speech. As indicated earlier, the acoustic input 305 corresponds to recorded acoustic signals in the environment where the associated client is conducting the meeting session. Such recorded acoustic input may contain some segments that have no speech except environmental sounds and some segments that contain compound speech and environmental sound. The acoustic based filtering mechanism 430 filters the acoustic input 305 and identifies the segments where speech is present.

Since speech recognition may be an expensive operation, excluding segments that have no speech information may improve the efficiency of the system. The acoustic based filtering mechanism 430 may serve that purpose. It may process the acoustic input 305 and identify the segments with no speech present. Such segments may be excluded from further speech recognition processing. In this case, only the speech input 435 is sent to the automatic speech recognition mechanism 445 for further speech recognition.

Whether to filter the acoustic input 305 prior to speech recognition may be set up either as a system parameter, specified prior to deployment of the system, or as a session parameter, specified by the associated participating client prior to entering the session.

The automatic speech recognition mechanism 445 generates a transcription in a preferred language (or source language) based on the speech of the associated client. When translation is determined to be necessary (either at the source or the destination site), the transcription may then be sent to the language translation mechanism 450 to generate one or more destination transcriptions in one or more destination languages. Each of the destination transcriptions may be in a different destination language created for the participating client(s) who specify the destination language as the preferred language.

If information about a participating client indicates that the destination language differs from the user's source language, translation from the source language to the destination language may be needed. For each of the participating client other than the associated client, the language translation mechanism 450 may invoke the destination speech feature identifier 425 to retrieve information relevant to the participating client in determining whether translation is necessary.

When the destination language differs, the language translation mechanism 450 retrieves appropriate language models for the purposes of translating the transcription in a source language to a transcription with the same content but in a different (destination) language. This yields transcription in destination language 320. During the translation, the language models in both the source and the destination languages may be used. When the source language is the same as the destination language, the transcription in the source language can be used as the transcription in destination language 320.

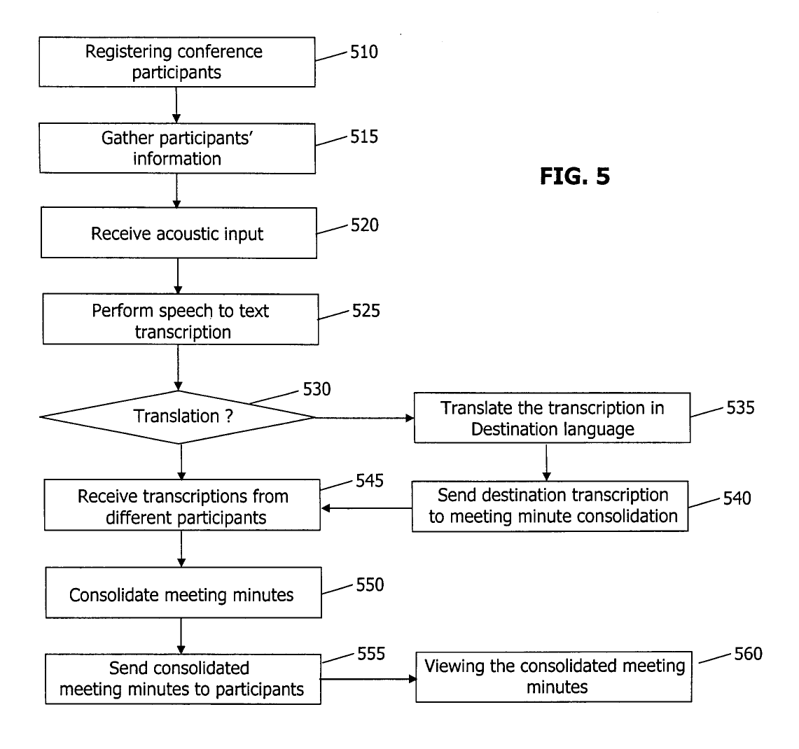

FIG. 5 is a flowchart of an exemplary process, in which meeting minutes of a multi-user voice enabled communication session are automatically generated and consolidated. A plurality of clients register for a meeting (or conference) session at act 510. The AMEMs associated with individual clients gather, at act 515, information about participating clients. During the meeting session, an AMEM associated with a client receives, at act 520, the acoustic input 305 obtained in an environment in which the client is participating the meeting session.

The acoustic input 305 may contain speech segments in a source language. For such portions of the acoustic input 305, the speech to text mechanism 315 of the associated AMEM performs, at act 525, speech to text processing to generate a transcription in the source language. To allow other participating clients to access the message of the client in their corresponding destination language(s), the speech to text mechanism 315 determines, at act 530, whether translation is needed.

If translation is needed, the speech to text mechanism 315 may translate, at act 535, the transcription in the source language into transcription(s) in destination language(s). The translated transcriptions in destination language(s) are then sent, at 540, to a meeting minute consolidation mechanism (which may be within the same device, or within the AMEM of a different client, or at a location different from any of the clients). When transcriptions from different clients are received, at 545, a meeting minutes update is generated, at 550. Such generated meeting minutes are sent, at act 555, to all the participating clients. The AMEM associated with the client may then, after receiving the meeting minutes update, view, at 560, the meeting minutes on their own devices.

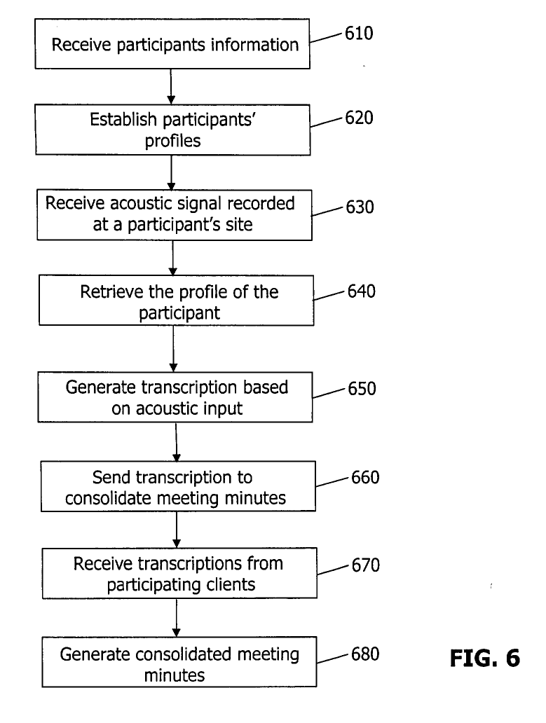

FIG. 6 is a flowchart of an exemplary process, in which an automatic meeting-minute enabling mechanism (AMEM) generates transcription and displays meeting minutes update to its associated client. Each of the AMEMs under the architecture 100 or the architecture 200 may be configured differently to perform varying functions according to what local applications require or how an associated client sets it up. The exemplary process described in FIG. 6 may illustrate some of the common functions performed by all AMEMs to enable multi-user meeting sessions. That is, the acts described in FIG. 6 do not limit what an individual AMEM may actually perform during run time.

Information related to participating clients is received first at act 610. Based on received information, the participant profile generation mechanisms (410) in individual AMEMs establish, at act 620, participant profiles 415. During a meeting session, the speech to text mechanism (315) receives, at act 630, the acoustic input 305 from the associated client. To automatically generate a transcription based on the acoustic input 305, the speech to text mechanism 315 may invoke the source speech feature identifier 420 to retrieve, at act 640, information related to the associated client. Such information may indicate the source language that the associated client prefers or other speech features such as accent. The retrieved information may then be used to select language and acoustic models to be used for speech recognition.

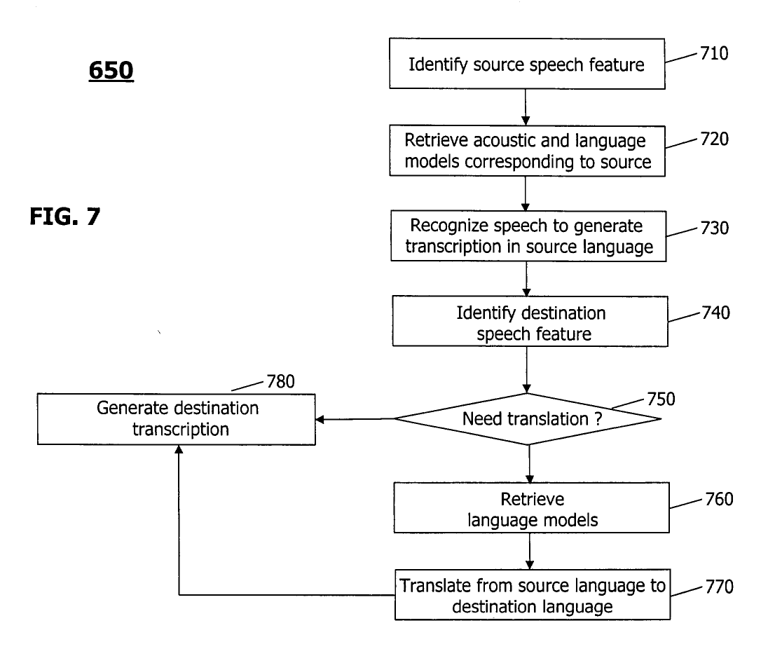

Based on selected language and acoustic models, the speech to text mechanism 315 automatically generates, at act 650, transcription based on the acoustic input 305. Specifics of this act are described in detail with reference to FIG. 7. The transcriptions may be generated in both the source language and one or more destination languages. The transcriptions in destination language(s) created for different participating clients are then sent, at act 660, to a meeting minute consolidation mechanism to produce a meeting minutes update. As discussed in different embodiments illustrated in FIGS. 3(a), 3(b), and 3(c), the meeting minute consolidation mechanism may be located on one of the AMEMs or deployed on a device that is independent of any of the clients involved. When the meeting minute consolidation mechanism receives, at 670, the transcriptions from different participating clients, a meeting minutes update is generated, at 680, based on the received transcriptions.

FIG. 7 is a flowchart of an exemplary process, in which spoken words are recognized based on speech of an associated client and translated into a transcription in a destination language. To recognize spoken words, the speech features related to the associated client are first identified at act 710. Such speech features may include the source language or possibly known accent of the speech. Based on known speech features, the automatic speech recognition mechanism 445 may retrieve, at act 720, language models and acoustic models consistent with the speech features and use such retrieved models to recognize, at act 730, the spoken words from the acoustic input 305.

The recognized spoken words form a transcription in the source language. To generate a meeting minute in a destination language according to the transcription, the language translation mechanism 450 may invoke the destination speech feature identifier 425 to identify, at act 740, information related to the speech features, such as the preferred or destination language, of a participating client. If the destination language is the same as the source language, determined at act 750, there may be no need to translate. In this case, a destination transcription in proper format is generated, at act 780, based on the transcription in the source language.

If the destination language differs from the source language, the transcription may need to be translated into the destination language before it is used to generate the meeting minute. In this case, the language translation mechanism 450 retrieves, at act 760, language models relevant to both the source and destination languages and uses retrieved language models to translate, at act 770, the transcription from the source language to the destination language. The translated transcription is then used to generate a corresponding meeting minute at act 780.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

What is claimed is:

1. A method, comprising:
registering a meeting in which a plurality of clients across a network participate;
receiving acoustic input containing speech data representing the speech of a client in a source language determined according to information related to the client, the client being one of the clients participating the meeting;
generating at least one transcription based on the speech of the client, translated into one or more destination languages, according to information related to other participating clients; and
consolidting transcriptions associated with the plurality of clients to generate consolidaed meeting minutes.

2. The method according to claim 1, wherein the information related the client includes a preferred language to be used by the client to participate in the meeting.

3. The method according to claim 2, wherein the source language associated with the client is the preferred language of the client, specified as the information related to the client; and
the one or more destination languages are the preferred languages of the participating clients who communicates with the client.

4. The method according to claim 3, wherein said generating at least one transcription in one or more destination languages comprises:
performing speech recognition on the speech data to generate a transcription in the source language;
translating the transcription in the source language into the one or more destination languages, when the destination languages of the participating clients differ from the source language, to generate the at least one transcription.

5. The method according to claim 4, further comprising:
gathering the information related to the client and the information related to the other participating clients prior to said performing.

6. A method for automatic meeting minute enabling, comprising:
receiving information about a plurality of clients who participate in a multi-user meeting;
receiving acoustic input containing speech data representing the speech of a client in a source language determined according to information related to the client, the client being one of the participating clients;
generating at least one transcription based on the speech of the client in one or more destination languages, translated according to information related to other participating clients, to the other participating clients; and
consolidting transcriptions associated with the plurality of clients to generate consolidaed meeting minutes.

7. The method according to claim 6, wherein
the source language associated with the client is specified in the information about the client as a preferred language of the client during the conferencing; and
the one or more destination languages are preferred languages of other participating clients specified in the information.

8. The method according to claim 7, wherein said at least one transcription in one or more destination languages comprises:
performing speech recognition based on the speech data to generate a transcription in the source language;
translating the transcription in the source language to generate one or more destination transcriptions, each of which in a distinct destination language, when the destination language of the other participating clients differ from the source language.

9. The method according to claim 8, wherein said performing comprises:
identifying the source language based on the information about the client;
retrieving acoustic and language models corresponding to the source language; and
recognizing spoken words from the speech data based on the acoustic and language models corresponding to the source language to generate the transcription.

10. The method according to claim 9, wherein said translating the transcription comprises:
identifying the destination language based on the information related to the other participating clients;
retrieving language models associated with the source language and the destination languages; and
translating the transcription in the source language into one or more destination languages using the language models associated with the source and destination languages.

11. The method according to claim 8, wherein said consolidating transcriptions comprises:
receiving transcriptions from the plurality of participating clients; and
consolidating the received transcriptions to generate the meeting minutes update.

12. A system, comprising:
a plurality of clients capable of connecting with each other via a network; and
a plurality of automatic meeting minute enabling mechanisms, each associating to one of the plurality of clients, capable of performing automatic transcription generation based on the associated client's speech in a source language.

13. The system according to claim 12, wherein each of the automatic meeting minute enabling mechanisms resides on a same communication device as the associated client to perform automatic meeting minute generation and consolidation.

14. The system according to claim 12, wherein each of the automatic meeting minute enabling mechanisms resides on a different communication device from the associated client and performs automatic meeting minute generation and consolidation across the network.

15. The system according to claim 14, wherein each of the automatic meeting minute enabling mechanisms includes:
a speech-to-text mechanism capable of generating at least one transcription for the associated client, with the at least one transcription containing words spoken by the associated client in a source language and translated into a destination language; and
a text viewing mechanism capable of displaying a consolidated meeting meniute to the associated client, the meeting minutes update being generated based on transcriptions generated by a plurality of speech-to-text mechanisms associated with the plurality of participating clients.

16. The system according to claim 15, further comprising a meeting minute consolidation mechanism capable of consolidating transcriptions from the plurality of participating clients generated by the plurality of speech-to-text mechanisms based on the speech of the plurality of participating clients to produce the meeting minutes update.

17. An automatic meeting minute enabling mechanism, comprising:
a speech-to-text mechanism capable of generating at least one transcription for an associated client, the at least one transcription containing words spoken by the associated client in a source language and translated into a destination language; and
a text viewing mechanism capable of displaying a consolidated meeting meniute to the associated client, the meeting minutes update being generated based on transcriptions generated by a plurality of speech-to-text mechanisms associated with a plurality of participating clients.

18. The mechanism according to claim 17, further comprising a meeting minute consolidation mechanism capable of consolidating transcriptions from the plurality of participating clients generated by the plurality of speech-to-text mechanisms based on the speech of the plurality of participating clients to produce the meeting minutes update.

19. The mechanism according to claim 18, further comprising:
an acoustic based filtering mechanism capable of identifying speech data based on acoutic input.

20. The mechanism according to claim 17, further comprising a participating client management mechanism.

21. The mechanism according to claim 20, wherein the participating client management mechanism includes:
a participant profile generation mechanism capable of establish relevant information about a plurality of clients participating a conferencing across a network;
a source speech feature identifier capable of identifying the source language and other features related to the speech of the associated client based on information relevant to the associated client; and
a destination speech feature identifier capable of identifying the destination language and other features related to the speech of other participating clients.

22. An article comprising a storage medium having stored thereon instructions that, when executed by a machine, result in the following:
registering a meeting in which a plurality of clients across a network participate;
receiving acoustic input containing speech data representing the speech of a client in a source language determined according to information related to the client, the client being one of the clients participating the meeting;
generating at least one transcription based on the speech of the client, translated into one or more destination languages, according to information related to other participating clients; and
consolidating transcriptions associated with the plurality of clients to generate meeting minutes update.

23. The article comprising a storage medium having stored thereon instructions according to claim 22, wherein generating at least one transcription in one or more destination languages comprises:
performing speech recognition on the speech data to generate a transcription in the source language;
translating the transcription in the source language into the one or more destination languages, when the destination languages of the participating clients differ from the source language, to generate the at least one transcription.

24. The article comprising a storage medium having stored thereon instructions according to claim 23, the instructions, when executed by a machine, further resulting in the following:
gathering the information related to the client and the information related to the other participating clients prior to said performing.

25. An article comprising a storage medium having stored thereon instructions for automatic meeting minute enabling, the instructions, when executed by a machine, result in the following:
receiving information about a plurality of clients who participate in a multi-user meeting;
receiving acoustic input containing speech data representing the speech of a client in a source language determined according to information related to the client, the client being one of the participating clients;
generating at least one transcription based on the speech of the client in one or more destination languages, translated according to information related to other participating clients, to the other participating clients; and
consolidating transcriptions associated with the plurality of clients to generate meeting minutes update.

26. The article comprising a storage medium having stored thereon instructions according to claim 25, wherein said generating at least one transcription in one or more destination languages comprises:
performing speech recognition based on the speech data to generate a transcription in the source language;
translating the transcription in the source language to generate one or more destination transcriptions, each of which in a distinct destination language, when the destination language of the other participating clients differ from the source language.

27. The article comprising a storage medium having stored thereon instructions according to claim 26, wherein said performing speech recognition comprises:
identifying the source language based on the information about the client;
retrieving acoustic and language models corresponding to the source language; and
recognizing spoken words from the speech data based on the acoustic and language models corresponding to the source language to generate the transcription.

28. The article comprising a storage medium having stored thereon instructions according to claim 27, wherein said translating the transcription comprises:
identifying the destination language based on the information related to the other participating clients;
retrieving language models associated with the source language and the destination languages; and
translating the transcription in the source language into one or more destination languages using the language models associated with the source and destination languages.

29. The article comprising a storage medium having stored thereon instructions according to claim 28, wherein said consolidating transcriptions comprises:
receiving transcriptions from the plurality of participating clients; and
consolidating the received transcriptions to generate the meeting minutes update.
